(19) United States
(12) Patent Application Publication
(10) Pub. No.: US 2024/0214247 A1
(43) Pub. Date: Jun. 27, 2024

(54) COMMUNICATION SYSTEM, RECEIVER, EQUALIZATION SIGNAL PROCESSING CIRCUIT, METHOD, AND NON-TRANSITORY COMPUTER READABLE MEDIUM

(71) Applicant: NEC Corporation, Tokyo (JP)

(72) Inventor: Manabu ARIKAWA, Tokyo (JP)

(73) Assignee: NEC Corporation, Tokyo (JP)

(21) Appl. No.: 18/538,140

(22) Filed: Dec. 13, 2023

(30) Foreign Application Priority Data
Dec. 19, 2022 (JP) 2022-202562

(51) Int. Cl. H04L 25/03

(52) U.S. Cl. CPC H04L 25/03159; H04L 25/03834

(57) ABSTRACT

A frequency domain conversion unit converts an input signal of oversampling of a first predetermined multiple into a signal in a frequency domain. A rate conversion unit converts a signal being multiplied by a coefficient by a frequency domain filter into a signal of oversampling of a second predetermined multiple. A time domain conversion unit converts the converted signal into a signal in a time domain. A gradient calculation unit calculates a gradient of a loss function for a filter coefficient by using an error back propagation method using, as the loss function, magnitude of a difference between a signal of oversampling of the second predetermined multiple being converted into a signal in the time domain, and a predetermined value determined by oversampling of the second predetermined multiple. A coefficient updating unit updates the coefficient of the frequency domain filter, based on the calculated gradient.

### INCORPORATION BY REFERENCE

This application is based upon and claims the benefit of priority from Japanese patent application No. 2022-202562, filed on Dec. 19, 2022, the disclosure of which is incorporated herein in its entirety by reference.

### TECHNICAL FIELD

The present disclosure relates to a communication system, a receiver, an equalization signal processing circuit, a method, and a non-transitory computer readable medium.

### BACKGROUND ART

Since introduction of so-called digital coherent technique, which combines coherent reception and digital signal processing, in optical fiber communication, flexible receiver side equalization signal processing by digital signal processing has become possible. In the receiver side equalization signal processing, for example, chromatic dispersion accumulated in an optical fiber transmission path is collectively compensated in a receiver side apparatus.

In the optical fiber communication, a high-speed and large-capacity signal is generally handled. For this reason, high throughput is also required for digital signal processing handling the optical fiber communication. Therefore, magnitude of a calculation amount required for the digital signal processing often becomes a problem. A response of an adaptive equalization filter is adaptively controlled according to a state of a transmission path. The adaptive equalization filter is one of important elements of the receiver side equalization signal processing in the optical fiber communication, and efficiency of the calculation amount is also required for the adaptive equalization filter.

When the adaptive equalization filter compensates for an effect with a large time spread, a large filter capable of expressing a response with a large time spread is used for the adaptive equalization filter, and in the adaptive equalization filter, the calculation amount required for compensation increases. As one of methods for efficiently compensating for the effect with the large time spread, adoption of a frequency domain filter has been considered. In a frequency domain, a convolution arithmetic operation of a filter response to an input signal in a time domain can be handled as simple multiplication. In addition, converting a time domain signal into the frequency domain can be efficiently performed by fast Fourier transform (FFT). For this reason, when a time spread of the response is large, a required calculation amount of the frequency domain filter is reduced as compared with that of a time domain filter.

As a related art, Non Patent Literature 1 (S. Haykin, “adaptive filter theory 4th edition”, (Prentice Hall, 2002, chap. 7)) discloses an adaptive frequency domain filter in which a response of a frequency domain filter is adaptively controlled. FIG. 9 illustrates an example of the adaptive frequency domain filter described in Non Patent Literature 1. The adaptive frequency domain filter is a linear adaptive filter. Typically, from a relationship of a Nyquist criterion, the linear adaptive filter operates on two samples of signal per symbol, i.e., an input signal of two-times oversampling.

In an adaptive frequency domain filter 600 illustrated in FIG. 9, a block conversion unit 601 converts a time domain input signal of two-times oversampling into a signal of a block having a certain length for conversion into a frequency domain. In other words, the block conversion unit 601 performs serial/block conversion on the time domain input signal. During the conversion into the frequency domain, periodicity of the blocked signal is assumed. However, for a signal handled in optical communication, assumption of the periodicity of a signal is not generally established. For this reason, an overlap-save method is used. In other words, a constant, e.g., 50% overlap between blocks is provided during serial/block conversion of the input signal.

An FFT 602 converts a blocked input signal into a frequency domain signal. A frequency domain filter 603 multiplies an input signal by a filter coefficient for each frequency. An inverse FFT (IFFT) 604 converts an output signal of the frequency domain filter 603 from a signal in the frequency domain to a signal in a time domain. A serial conversion unit 605 converts a blocked signal converted into a signal in the time domain by the IFFT 604 into a serial signal. In other words, the serial conversion unit 605 performs block/serial conversion on an output signal of the IFFT 604. In the conversion into a serial signal, the serial conversion unit 605 leaves only a domain of an output signal of the IFFT 604 not being affected by the assumption of the above-described periodicity, and removes other domains. A coefficient of the frequency domain filter 603 is adaptively controlled by using an input signal of the frequency domain filter 603 and an output signal of the serial conversion unit 605.

Herein, an input signal vector being blocked by the block conversion unit 601 is denoted by x. It is assumed that a length of x is 4N. x is a signal of two-times oversampling, and is represented by the following equation 1 with a symbol interval of T.

$$x = {( x ( 0 ) , x ( T / 2 ) , … , x ( ( 4 N - 1 ) T / 2 ) )}^{T} \qquad ( 1 )$$

When a signal vector acquired by converting the input signal vector x into the frequency domain is denoted by X, an input signal vector X in the frequency domain is represented by the following equation 2.

$$X = {( X ( 0 ) , X ( {F}_{0} ) , … , X ( ( 4 N - 1 ) {F}_{0} ) )}^{T} \qquad ( 2 )$$

Assuming k, n=0, 1, . . . , 4N-1, the following equations 3 and 4 are established.

$$x ( n \frac{T}{2} ) = \frac{1}{4 N} {\sum }_{k = 0}^{4 N - 1} X ( {kF}_{0} ) exp ( i \frac{2 π kn}{4 N} ) \qquad ( 3 )$$

$$X ( {kF}_{0} ) = {\sum }_{n = 0}^{4 N - 1} x ( n \frac{T}{2} ) exp ( - i \frac{2 π kn}{4 N} ) \qquad ( 4 )$$

In the above-described equations 3 and 4, F₀=2Rₛ/(4N) and Rₛ=1/T.

A filter coefficient vector of the frequency domain filter 603 is denoted by H, and an output vector of the frequency domain filter 603 is denoted by Y₊. An arithmetic operation of a filter coefficient in the frequency domain is represented as an Hadamard product of the filter coefficient vector H and the input signal vector X, as indicated in the following equation 5.

$${Y}_{+} = H \cdot X \qquad ( 5 )$$

A signal vector acquired by converting the output signal vector Y₊of the frequency domain filter 603 into the time domain by the IFFT 604 is denoted by Y₊. The output signal vector Y₊in the time domain includes a domain y not being affected by the assumption of the periodicity and a domain y^{˜} that may be affected by the assumption of the periodicity, as indicated in the following equation 6.

$${y}_{+} = ( \begin{matrix}y \\ {y}^{\sim}\end{matrix} ) \qquad ( 6 )$$

The serial conversion unit 605 removes the domain y^{˜} that may be affected by the assumption of the periodicity from the output signal vector Y₊represented by the above-described equation 6, leaves only the domain y, and then performs the block/serial conversion. When assuming 50% overlap, a length of each of y and y^{˜} becomes 2N. The serial conversion unit 605 repeatedly performs the above-described processing for each overlapped block. A signal acquired by sequentially connecting the signal y being subject to serial conversion by the serial conversion unit 605 becomes a time domain signal to be output from the adaptive frequency domain filter 600.

The above-described signal y is a signal being subject to two-times oversampling. In the adaptive frequency domain filter 600, in order to acquire an output signal of one-time oversampling, for example, in the serial conversion unit 605, two-times down-sampling is performed on the signal y. A length of a signal being subject to down-sampling per block is N. Depending on an algorithm to be used for adaptive control of the filter coefficient, an output signal y_{↓2} being subject to down-sampling may be subject to phase rotation for carrier phase compensation and frequency offset compensation, and updating of the filter coefficient may be performed.

When a least mean square (LMS) algorithm is used for updating the filter coefficient, the coefficient of the frequency domain filter 603 is updated as follows. A desired signal for the output signal being subject to two-times down-sampling y_{↓2} is denoted by d. When a data-aided LMS algorithm is used, d is a known training signal. When a decision-directed LMS algorithm is used, d is a result of symbol determination of the output signal y_{↓2}. Updating of the frequency domain filter coefficient using the LMS algorithm is represented by the following expression 7.

$$H \to H + 2 {αX}^{*} ∘ D ( \begin{matrix}{e}_{↑ 2} \\ 0\end{matrix} ) \qquad ( 7 )$$

In the above-described expression 7, D is a discrete Fourier transform (DFT) matrix, and a is a step size of the updating. A second term on a right side in the above-described expression 7 represents an update amount of the coefficient.

An error calculation unit 611 calculates an error e between the down-sampled output signal y_{2↓}of one-time oversampling and the desired signal d by the following equation 8.

$$e = d - {y}_{↓ 2} \qquad ( 8 )$$

The error calculation unit 611 outputs a signal e_{↑2} acquired by two-times up-sampling the error e. The error calculation unit 611 may calculate the error e_{↑2} by the following equation 9, when it is assumed that d_{↑2} is a signal acquired by two-times up-sampling the desired signal d.

$${e}_{↑ 2} = {d}_{↑ 2} - y \qquad ( 9 )$$

A zero insertion unit 612 concatenates a zero vector to the above-described error e_{↑2} being subject to two-times up-sampling. In other words, the zero insertion unit 612 generates a vector (e_{↑2}, 0)^{T} included in the second term on the right side in the above-described expression 7. A part of the zero vector in the vector (e_{↑2}, 0)^{T} is a part corresponding to y^{˜} being removed by the block/serial conversion. An FFT 613 multiplies the vector (e_{↑2}, 0)^{T} by the DFT matrix D, and thereby converts an error signal vector into a frequency domain signal. Multiplying the vector (e_{↑2}, 0)^{T} by the DFT matrix D is equivalent to performing an FFT on the error signal vector.

A complex conjugate calculation unit 614 calculates complex conjugate of the input frequency domain signal X being output from the FFT 602. An Hadamard product calculation unit 615 calculates an Hadamard product of the complex conjugate of the input frequency domain signal X and the error signal vector converted into a frequency domain signal by the FFT 613. A result acquired by multiplying a calculation result of the Hadamard product calculation unit 615 by the step size a is equivalent to a coefficient update amount indicated by the second term on the right side in the above-described expression 7.

An IFFT 616 converts the calculation result of the Hadamard product calculation unit 615 being equivalent to the coefficient update amount in the frequency domain into a signal in the time domain. A zero replacement unit 617 replaces, with zero, a coefficient of the domain being equivalent to an overlap length in the signal converted into the signal in the time domain by the IFFT 616. An FFT 618 converts a signal replaced with zero into a frequency domain signal, i.e., a coefficient update amount in the frequency domain. When the time spread of the response of the frequency domain filter 603 exceeds a time length of the overlap, an effect of wraparound at both ends of the block of the input signal assuming the periodicity cannot be removed even when only y is left in the serial conversion unit 605. The IFFT 616, the zero replacement unit 617, and the FFT 618 are necessary in order to avoid the effect of the wraparound at both ends of the block due to the assumption of the periodicity in the frequency domain filter and to acquire an operation equivalent to the time domain filter, and the operation is referred to as a constraint in the time domain.

A coefficient updating unit 619 multiplies an output of the FFT 618 by the step size α. The coefficient updating unit 619 outputs the coefficient update amount being multiplied by the step size α to the frequency domain filter 603, and updates the filter coefficient of the frequency domain filter 603. The above-described expression 7 can be transformed into the following expression 10 by using a vector c=(1,0)^{T} for appropriate coefficient zero replacement.

$$H \to H + 2 α Dc ∘ ( {D}^{- 1} ( {X}^{*} ∘ D ( \begin{matrix}{e}_{↑ 2} \\ 0\end{matrix} ) ) ) \qquad ( 10 )$$

By performing such an operation, adaptive control of the frequency domain filter coefficient is performed. Note that, in the above description, an example of a case where an input/output signal is a one-dimensional signal has been described. However, the above-described operation of coefficient updating is easily extended even in a case where a filter is a multi-input multi-output (MIMO) filter.

As described above, the existing adaptive frequency domain filter described in Non Patent Literature 1 operates on an input signal of two-times oversampling. In contrast, there is an attempt to reduce a sampling rate of an input signal of an adaptive filter into less than two times and reduce a calculation amount. For example, Non Patent Literature 2 (C. Li, et al., “Advanced DSP for single-carrier 400-Gb/s PDM-16QAM,” OFC 2016, W4A.4) discloses an example of an adaptive filter that operates in the time domain on an input signal having an oversampling rate being less than two times and not being an integer multiple of a symbol rate. In addition, Non Patent Literature 3 (M. Paskov, et al., “A fully-blind fractionally-oversampled frequency domain adaptive equalizer,” OFC 2016, Th2A.33) discloses an example of an adaptive filter that operates in the frequency domain on an input signal having an oversampling rate being less than two times and not being an integer multiple of the symbol rate.

The adaptive filter described in Non Patent Literature 3 converts an input signal into a signal in the frequency domain, performs appropriate zero insertion on the signal in the frequency domain, and operates in the frequency domain of two-times oversampling. As described above, the frequency domain filter is multiplication of a coefficient for each frequency. For this reason, even in a case of the adaptive filter described in Non Patent Literature 3 and the frequency domain signal being equivalent to the two-times oversampling, calculation may be performed only on a frequency component not being zero, and the calculation amount of the frequency domain filter is made efficient.

### SUMMARY

However, in the adaptive filter described in Non Patent Literature 3, for adaptive coefficient updating, it is necessary to calculate an update amount for a frequency domain filter coefficient of two-times oversampling. In order to calculate the update amount of the frequency domain filter coefficient, as described above, an FFT of an error appropriately inserted at zero, and an IFFT and an FFT for a constraint of the coefficient update amount in the time domain are required. These calculation amounts depend on a size of the error and the coefficient update amount to be handled, and as the size increases, the calculation amount increases. In addition, the larger the oversampling rate to be handled, the smaller a time width per sample. For this reason, when the time width of the filter is constant, it is necessary to handle a filter coefficient of a large size, an error, and a coefficient update amount in the frequency domain of two-times oversampling as compared with a case of the oversampling rate less than two times. Therefore, this leads to an increase in calculation amount over an adaptive filter operating in the frequency domain of oversampling less than two times.

An example object of the present disclosure is to provide a communication system, a receiver, an equalization signal processing circuit, a method, and a program that are capable of adaptively controlling a coefficient of a frequency domain filter while reducing a calculation amount.

In order to achieve the above-described object, in a first example aspect of the present disclosure, an equalization signal processing circuit includes: a frequency domain conversion unit configured to convert an input signal of oversampling of a first predetermined multiple into a signal in a frequency domain; a frequency domain filter configured to multiply an input signal being converted into the frequency domain by a coefficient for each frequency; a rate conversion unit configured to convert a signal being multiplied by a coefficient by the frequency domain filter into a signal of oversampling of a second predetermined multiple; a time domain conversion unit configured to convert a signal being converted into a signal of oversampling of the second predetermined multiple by the rate conversion unit into a signal in a time domain; a gradient calculation unit configured to calculate a gradient of a loss function for the coefficient by using an error back propagation method using, as the loss function, magnitude of a difference between a signal of oversampling of the second predetermined multiple being converted into a signal in the time domain, and a predetermined value determined by oversampling of the second predetermined multiple; and a coefficient updating unit configured to update the coefficient of the frequency domain filter, based on the calculated gradient of the loss function for the coefficient.

In a second example aspect of the present disclosure, a receiver includes: a detector configured to coherently receive a signal being transmitted from a transmitter via a transmission path; and an equalization signal processing circuit configured to perform equalization signal processing on the coherently received input signal of oversampling of a first predetermined multiple. The equalization signal processing circuit includes: a frequency domain conversion unit configured to convert the input signal into a signal in a frequency domain; a frequency domain filter configured to multiply an input signal being converted into the frequency domain by a coefficient for each frequency; a rate conversion unit configured to convert a signal being multiplied by a coefficient by the frequency domain filter into a signal of oversampling of a second predetermined multiple; a time domain conversion unit configured to convert a signal being converted into a signal of oversampling of the second predetermined multiple by the rate conversion unit into a signal in a time domain; a gradient calculation unit configured to calculate a gradient of a loss function for the coefficient by using an error back propagation method using, as the loss function, magnitude of a difference between a signal of oversampling of the second predetermined multiple being converted into a signal in the time domain, and a predetermined value determined by oversampling of the second predetermined multiple; and a coefficient updating unit configured to update the coefficient of the frequency domain filter, based on the calculated gradient of the loss function for the coefficient.

In a third example aspect of the present disclosure, a communication system includes: a transmitter configured to transmit a signal via a transmission path; and a receiver configured to receive the transmitted signal. The receiver includes: a detector configured to coherently receive a signal being transmitted from the transmitter; and an equalization signal processing circuit configured to perform equalization signal processing on the coherently received input signal of oversampling of a first predetermined multiple. The equalization signal processing circuit includes: a frequency domain conversion unit configured to convert the input signal into a signal in a frequency domain; a frequency domain filter configured to multiply an input signal being converted into the frequency domain by a coefficient for each frequency; a rate conversion unit configured to convert a signal being multiplied by a coefficient by the frequency domain filter into a signal of oversampling of a second predetermined multiple; a time domain conversion unit configured to convert a signal being converted into a signal of oversampling of the second predetermined multiple by the rate conversion unit into a signal in a time domain; a gradient calculation unit configured to calculate a gradient of a loss function for the coefficient by using an error back propagation method using, as the loss function, magnitude of a difference between a signal of oversampling of the second predetermined multiple being converted into a signal in the time domain, and a predetermined value determined by oversampling of the second predetermined multiple; and a coefficient updating unit configured to update the coefficient of the frequency domain filter, based on the calculated gradient of the loss function for the coefficient.

In a fourth example aspect of the present disclosure, an equalization signal processing method includes: converting an input signal of oversampling of a first predetermined multiple into a signal in a frequency domain; multiplying, by a frequency domain filter, an input signal being converted into the frequency domain by a coefficient for each frequency; converting a signal being multiplied by a coefficient by the frequency domain filter into a signal of oversampling of a second predetermined multiple; converting a signal being converted into a signal of oversampling of the second predetermined multiple into a signal in a time domain; calculating a gradient of a loss function for the coefficient by using an error back propagation method using, as the loss function, magnitude of a difference between a signal of oversampling of the second predetermined multiple being converted into a signal in the time domain, and a predetermined value determined by oversampling of the second predetermined multiple; and updating the coefficient of the frequency domain filter, based on the calculated gradient of the loss function for the coefficient.

In a fifth example aspect of the present disclosure, a program causes a processor to execute processing of: converting an input signal of oversampling of a first predetermined multiple into a signal in a frequency domain; multiplying, by a frequency domain filter, an input signal being converted into the frequency domain by a coefficient for each frequency; converting a signal being multiplied by a coefficient by the frequency domain filter into a signal of oversampling of a second predetermined multiple; converting a signal being converted into a signal of oversampling of the second predetermined multiple into a signal in a time domain; calculating a gradient of a loss function for the coefficient by using an error back propagation method using, as the loss function, magnitude of a difference between a signal of oversampling of the second predetermined multiple being converted into a signal in the time domain, and a predetermined value determined by oversampling of the second predetermined multiple; and updating the coefficient of the frequency domain filter, based on the calculated gradient of the loss function for the coefficient.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram schematically illustrating a configuration example of a communication system according to the present disclosure;

FIG. 2 is a block diagram illustrating a schematic configuration example of a receiver;

FIG. 3 is a block diagram illustrating a signal transmission system according to the present disclosure;

FIG. 4 is a block diagram illustrating an example of digital signal processing in an equalization unit;

FIG. 5 is a block diagram illustrating a configuration example of polarization separation/carrier phase compensation;

FIG. 6 is a block diagram illustrating a process of adaptive equalization signal processing on a main signal;

FIG. 7 is a block diagram illustrating a process of calculating a gradient by error back propagation for coefficient updating; FIG. 8 is a constellation of an adaptive frequency domain filter output signal;

FIG. 9 is a block diagram illustrating an example of an adaptive frequency domain filter in the related art; and

FIG. 10 is a block diagram illustrating a configuration example of a digital signal processing circuit.

### EXAMPLE EMBODIMENT

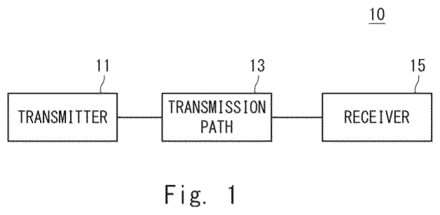

Prior to the description of an example embodiment of the present disclosure, an outline of the present disclosure will be described. FIG. 1 schematically illustrates a configuration example of a communication system according to the present disclosure. A communication system 10 includes a transmitter 11, and a receiver 15. The transmitter 11 and the receiver 15 are connected to each other via a transmission path 13. The transmitter 11 transmits a signal via the transmission path 13. The receiver 15 receives a signal transmitted from the transmitter 11 via the transmission path 13.

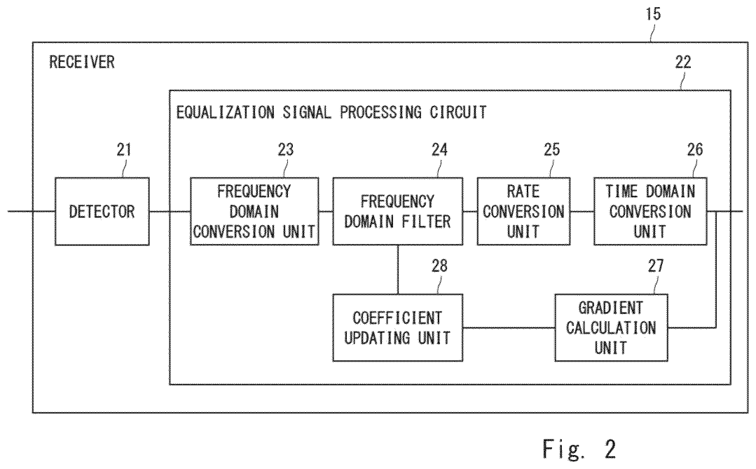

FIG. 2 illustrates a schematic configuration example of the receiver 15. The receiver 15 includes a detector 21, and an equalization signal processing circuit 22. The detector 21 coherently receives a signal transmitted from the transmitter 11. The equalization signal processing circuit 22 performs equalization signal processing on a coherently received input signal of oversampling of a predetermined multiple.

The equalization signal processing circuit 22 includes a frequency domain conversion unit 23, a frequency domain filter 24, a rate conversion unit 25, a time domain conversion unit 26, a gradient calculation unit 27, and a coefficient updating unit 28. The frequency domain conversion unit 23 converts an input signal of oversampling of a first predetermined multiple into a signal of a frequency domain. The frequency domain filter 24 multiplies the input signal being converted into the frequency domain by a coefficient for each frequency. The rate conversion unit 25 converts the signal multiplied by the coefficient by the frequency domain filter 24 into a signal of oversampling of a second predetermined multiple. Herein, it is assumed that the second predetermined multiple is smaller than the first predetermined multiple. The time domain conversion unit 26 converts the signal in the frequency domain being converted into a signal of oversampling of the second predetermined multiple by the rate conversion unit 25 into a time domain signal.

The gradient calculation unit 27 calculates a gradient for the coefficient of the frequency domain filter 24 of a loss function by using an error back propagation method, using, as the loss function, magnitude of a difference between a signal of one-time oversampling being converted into a signal in the time domain by the time domain conversion unit 26, and a predetermined value determined by oversampling of the second predetermined multiple. The coefficient updating unit 28 updates the coefficient of the frequency domain filter 24, based on the gradient of the loss function for the coefficient calculated by the gradient calculation unit 27.

In the present disclosure, the rate conversion unit 25 converts a signal of oversampling of the first predetermined multiple into a signal of oversampling of the second predetermined multiple in the frequency domain. In other words, the rate conversion unit 25 converts a rate of a signal in the frequency domain from the first predetermined multiple to the second predetermined multiple for which a predetermined value is determined. The gradient calculation unit 27 calculates the gradient of the loss function for the filter coefficient by using the error back propagation method, using, as the loss function, magnitude of a difference between a signal in the time domain being converted into a signal of oversampling of the second predetermined multiple, and a predetermined value determined by oversampling of the second predetermined multiple. The coefficient updating unit 28 updates the filter coefficient of the frequency domain filter 24 by using the gradient of the loss function for the filter coefficient. In the present example embodiment, a filter arithmetic operation and adaptive control of the filter coefficient can be performed without converting into the frequency domain of two-times oversampling. For this reason, the equalization signal processing circuit 22 can adaptively control the coefficient of the frequency domain filter 24 while reducing a calculation amount.

Note that, in the present disclosure, the equalization signal processing circuit 22 may include another filter, in addition to the frequency domain filter 24 whose coefficient is adaptively controlled. For example, the equalization signal processing circuit 22 may include an equalization filter having a static coefficient, such as a chromatic dispersion compensation filter or a matched filter, before the frequency domain filter 24.

Hereinafter, the example embodiment of the present disclosure will be described in detail with reference to the drawings. Note that, the following description and the drawings are omitted and simplified as appropriate for clarity of description. In addition, in each of the following drawings, the same elements and the similar elements are denoted by the same reference signs, and redundant descriptions are omitted as necessary.

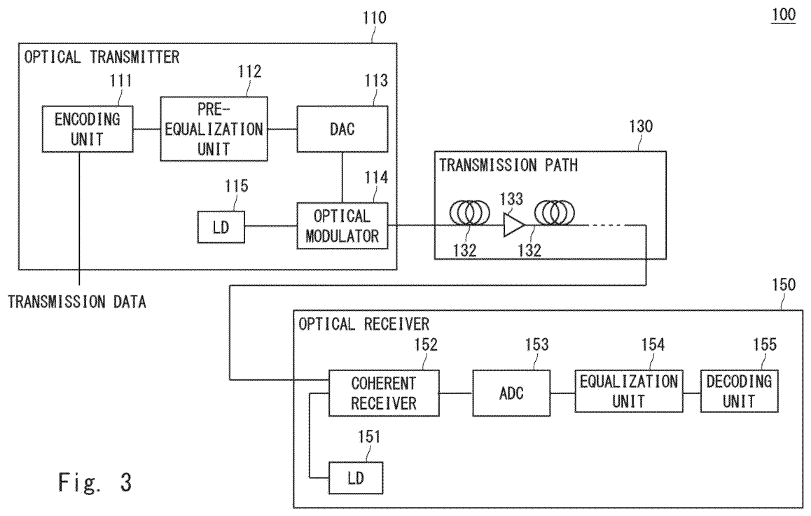

One example embodiment of the present disclosure will be described. In the present example embodiment, it is assumed that a signal transmission system is an optical fiber communication system that adopts a polarization multiplexing QAM system and performs coherent reception. A configuration example of an optical fiber communication system 100 will be described with reference to FIG. 3. The optical fiber communication system 100 includes an optical transmitter 110, a transmission path 130, and an optical receiver 150. The optical fiber communication system 100 constitutes, for example, an optical submarine cable system. The optical fiber communication system 100 corresponds to the communication system 10 illustrated in FIG. 1. The optical transmitter 110 corresponds to the transmitter 11 illustrated in FIG. 1. The transmission path 130 corresponds to the transmission path 13 illustrated in FIG. 1. The optical receiver 150 corresponds to the receiver 15 illustrated in FIG. 1.

The optical transmitter 110 converts transmission data into a polarization multiplexed optical signal. The optical transmitter 110 includes an encoding unit 111, a pre-equalization unit 112, a digital analog converter (DAC) 113, an optical modulator 114, and a laser diode (LD) 115. The encoding unit 111 encodes the transmission data, and generates a signal sequence for optical modulation. In a case of the polarization multiplexing QAM system, the encoding unit 111 generates a total of four series of signals being an in-phase (I) component and a quadrature (Q) component of each of X polarization (first polarization) and Y polarization (second polarization), respectively. Note that, in FIG. 3, for the sake of simplification of the drawings, encoded four-series signals are illustrated as one solid line. Hereinafter, one solid line illustrated in FIG. 3 may collectively represent signal series having a predetermined number, as a physical entity.

The pre-equalization unit 112 performs pre-equalization for compensating for known distortion or the like of a device in the optical transmitter 110 in advance for the encoded four-series signal. The DAC 113 converts each of the four-series signals being subject to the pre-equalization into an analog electric signal. The LD115 outputs continuous wave (CW) light. The optical modulator 114 modulates the CW light output from the LD 115 in response to the four-series signal output from the DAC 113, and generates an optical signal of polarization multiplexed QAM. The optical signal generated by the optical modulator 114, i.e., the polarization multiplexed optical signal is output to the transmission path 130.

The transmission path 130 transmits the polarization multiplexed optical signal output from the optical transmitter 110 to the optical receiver 150. The transmission path 130 includes an optical fiber 132, and an optical amplifier 133. The optical fiber 132 guides an optical signal transmitted from the optical transmitter 110. The optical amplifier 133 amplifies an optical signal, and compensates for a propagation loss in the optical fiber 132. The optical amplifier 133 is configured, for example, as an erbium doped fiber amplifier (EDFA). The transmission path 130 may include a plurality of optical fibers 132 and a plurality of optical amplifiers 133.

The optical receiver 150 receives an optical signal from the transmission path 130. The optical receiver 150 includes an LD 151, a coherent receiver 152, an analog digital converter (ADC) 153, an equalization unit 154, and a decoding unit 155. In the optical receiver 150, circuits such as the equalization unit (equalizer) 154 and the decoding unit (decoder) 155 may be configured by using a device such as a digital signal processor (DSP), for example.

The LD 151 outputs CW light as local oscillator light. In the present example embodiment, the coherent receiver 152 is configured as a polarization diversity type coherent receiver. The coherent receiver 152 performs coherent detection on an optical signal transmitted through the transmission path 130, by using the CW light output from the LD 151. The coherent receiver 152 outputs a four-series reception signal (electric signal) being equivalent to the I component and the Q component of the X polarization and the Y polarization being subject to coherent detection. The coherent receiver 152 corresponds to the detector 21 illustrated in FIG. 2.

The ADC 153 samples the reception signal output from the coherent receiver 152 and converts the reception signal into a signal in a digital domain. The equalization unit 154 performs receiver side equalization signal processing on the four-series reception signal being sampled by the ADC 153. The equalization unit 154 performs equalization signal processing on the reception signal, and thereby compensates for various pieces of distortion in the optical fiber communication system. The decoding unit 155 decodes the signal being subject to the equalization signal processing by the equalization unit 154, and restores the transmitted data. The decoding unit 155 outputs the restored data to not-illustrated another circuit.

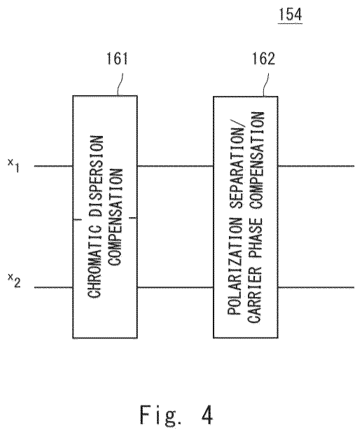

FIG. 4 illustrates an example of digital signal processing in the equalization unit 154. The equalization unit 154 includes a chromatic dispersion compensation 161 and a polarization separation/carrier phase compensation 162. The equalization unit 154 is input a two-series complex signal acquired by converting a sampled four-series reception signal into a complex phasor display for each polarization. The chromatic dispersion compensation 161 performs chromatic dispersion compensation for each polarization. The chromatic dispersion compensation 161 includes a fixed or quasi-static filter whose filter coefficient is determined in such a way as to compensate for chromatic dispersion accumulated in an optical transmission path.

The polarization separation/carrier phase compensation 162 is input a two-series complex signal associated to each of the polarization subjected to chromatic dispersion compensation by the wave chromatic length dispersion compensation 161. The polarization separation/carrier phase compensation 162 performs polarization separation and carrier phase compensation on the input two-series complex signal. A change in a polarization state occurring in the optical transmission path varies with time due to minute pressure to an optical fiber and a temperature change. For this reason, a filter for compensating for the change in the polarization state needs to be adaptively controlled. The equalization signal processing circuit according to the present example embodiment is used for the polarization separation/carrier phase compensation 162. Note that, a method described in the present example embodiment can be extended and applied to a case where linear and nonlinear distortion occurring in the optical transmitter 110 and the optical receiver 150 is subject to adaptive equalization by using a nonlinear filter represented by a Widely linear filter or a Volterra filter.

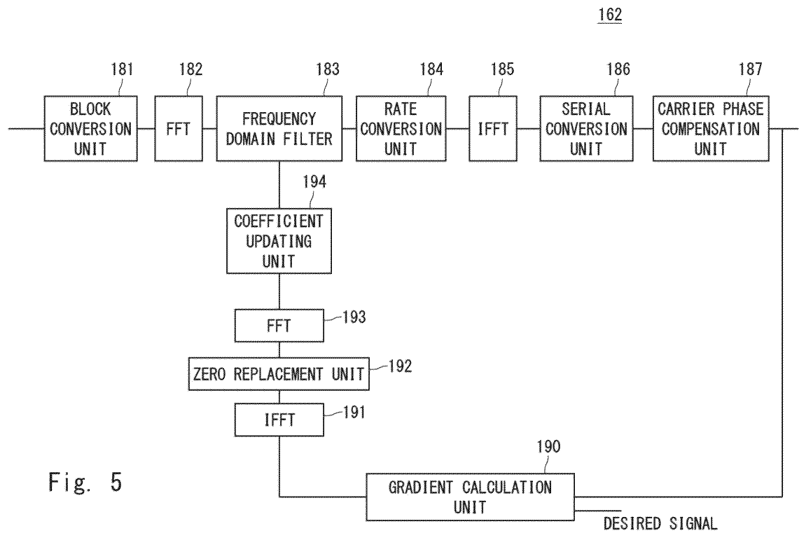

FIG. 5 illustrates a configuration example of the polarization separation/carrier phase compensation 162. The polarization separation/carrier phase compensation 162 includes a block conversion unit 181, an FFT 182, a frequency domain filter 183, a rate conversion unit 184, an IFFT 185, a serial conversion unit 186, a carrier phase compensation unit 187, a gradient calculation unit 190, an IFFT 191, a zero replacement unit 192, an FFT 193, and a coefficient updating unit 194. The polarization separation/carrier phase compensation 162 corresponds to the equalization signal processing circuit 22 illustrated in FIG. 2. Operation of the polarization separation/carrier phase compensation 162 is also referred to as an equalization signal processing method.

Note that, in FIG. 5, compensation in the polarization separation/carrier phase compensation 162 is performed by using a 2×2 adaptive MIMO filter, but for the sake of simplicity, FIG. 5 describes an example of a case where an input/output is a one-series complex signal. Operation described below can be easily extended to the adaptive MIMO filter. The configuration illustrated in FIG. 5 is generally an overlap-save type adaptive frequency domain filter.

An input signal is a signal of oversampling of the first predetermined multiple. In the present example embodiment, it is assumed that an input signal is a signal of oversampling of a non-integer and rational number multiple. In this case, the input signal is a complex signal series of oversampling of M/L, i.e., a complex signal series having a sampling interval LT/M when a symbol interval is T. Herein, it is assumed that M and L are integers satisfying 1<M/L≤2. The block conversion unit 181 performs serial/block conversion on the input complex signal series while providing a constant overlap between blocks for conversion to the frequency domain. Herein, an overlap rate is assumed to be 50%. The FFT 182 converts a blocked input signal into a signal in the frequency domain. The frequency domain filter 183 performs filtering processing on a signal in the frequency domain. In the present example embodiment, the frequency domain filter 183 is a MIMO filter. In the filtering processing, the frequency domain filter 183 multiplies by a filter coefficient for each frequency. The FFT 182 corresponds to the frequency domain conversion unit 23 illustrated in FIG. 2. The frequency domain filter 183 corresponds to the frequency domain filter 24 illustrated in FIG. 2.

The frequency domain filter 183 is a frequency domain filter that operates in the frequency domain of M/L times oversampling, i.e., in the frequency domain of oversampling of less than two times and not an integer multiple of the symbol rate. The frequency domain filter 183 outputs a frequency domain signal of M/L times oversampling. The rate conversion unit 184 converts the frequency domain signal of M/L times oversampling to be output from the frequency domain filter 183 into a frequency domain signal of oversampling of the second predetermined multiple. The rate conversion unit 184 converts, for example, a frequency domain signal of M/L times oversampling into a frequency domain signal of one-time oversampling. The IFFT 185 converts a frequency domain signal of one-time oversampling converted by the rate conversion unit 184 into a time domain block signal. The rate conversion unit 184 corresponds to the rate conversion unit 25 illustrated in FIG. 2. The IFFT 185 corresponds to the time domain conversion unit 26 illustrated in FIG. 2.

The serial conversion unit 186 converts the time domain block signal of one-time oversampling being converted by the IFFT 185 into a time domain serial signal of one-time oversampling. In the conversion into a serial signal, the serial conversion unit 186 leaves only a domain not being affected by assumption of periodicity at a time of conversion into the frequency domain in the time domain block signal of one-time oversampling, and removes the others.

The carrier phase compensation unit 187 performs phase rotation for removing a carrier phase and a frequency offset on the time domain serial signal of one-time oversampling being converted by the serial conversion unit 186. The carrier phase compensation unit 187 is multiplication in the time domain. The time domain serial signal of one-time oversampling output from the carrier phase compensation unit 187 is output with respect to one block. The above-described operation is performed for each of the blocks provided overlap, the output signals are connected to each other, and thereby a final output of the overlap-save type adaptive frequency domain filter illustrated in FIG. 5 is acquired.

The gradient calculation unit 190 calculates a gradient of a loss function for the filter coefficient using, as the loss function, magnitude of a difference between the time domain signal of one-time oversampling and a desired signal. Herein, the desired signal is determined by one-time oversampling. The gradient calculation unit 190 calculates a gradient of the loss function for the filter coefficient by error back propagation. The coefficient updating unit 194 adaptively controls the filter coefficient of the frequency domain filter 183 by a stochastic gradient descent method in such a way as to minimize the loss function, based on the gradient of the loss function for the filter coefficient. The gradient calculation unit 190 corresponds to the gradient calculation unit 27 illustrated in FIG. 2. The coefficient updating unit 194 corresponds to the coefficient updating unit 28 illustrated in FIG. 2.

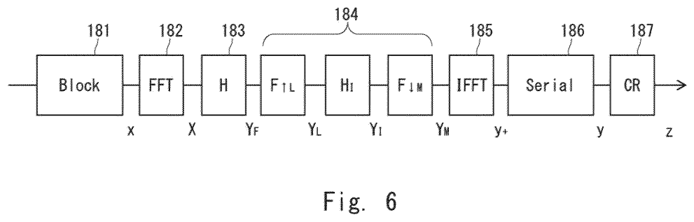

An arithmetic operation of an overlap-save type frequency domain filter operating in the frequency domain of M/L times oversampling and the adaptive control of the filter coefficient will be described more specifically with a focus on one certain input block. FIG. 6 illustrates a process of the adaptive equalization signal processing to a main signal in the present example embodiment. An input signal vector blocked by the block conversion unit 181 is referred to as x. x is a signal of the time domain of M/L times oversampling. In other words, x is a time domain signal with a sampling rate MRₛ/L, where Rₛ=1/T.

A size of a time domain serial signal of one-time oversampling to be output for the one block input signal and being subject to carrier phase compensation is referred to as N. In that case, a size of the blocked input signal x becomes N′=2 MN/L, assuming that the overlap rate is 50%. In that case, x is represented by the following equation 11.

$$x = {( x ( 0 ) , x ( {T}^{′} ) , … , x ( ( {N}^{′} - 1 ) {T}^{′} ) )}^{T} \qquad ( 11 )$$

In the above-described equation 11, T′=LT/M. The FFT 182 converts the time domain signal vector x into a frequency domain signal vector X. A size of X is N′, similar to the size of x, and X is represented by the following equation 12.

$$X = {( X ( 0 ) , X ( {F}_{0} ) , … , X ( ( {N}^{′} - 1 ) {F}_{0} ) )}^{T} \qquad ( 12 )$$

In the above-described equation 12, F₀=MRₛ/L/‘N′=Rₛ/(2N). x and X are in a relationship of the following equation 13.

$$X ( {kF}_{0} ) = X [ k ] = {\sum }_{n = 0}^{{N}^{′} - 1} x ( {nT}^{′} ) exp ( - i \frac{2 π kn}{{N}^{′}} ) \qquad ( 13 )$$

The above-described equation 13 can be rewritten into the following equation 14 by using a DFT matrix D.

$$X = Dx \qquad ( 14 )$$

The frequency domain filter 183 is a filter that operates with M/L times oversampling. A filter coefficient vector of the frequency domain filter 183 is referred to as H. A size of H is N′, similar to the size of X, and H is represented by the following equation 15.

$$H = {( H ( 0 ) , H ( {F}_{0} ) , … , H ( ( {N}^{′} - 1 ) {F}_{0} ) )}^{T} \qquad ( 15 )$$

Similarly to a case of X, it is represented as H(kF₀)=H[k]. An output of the frequency domain filter 183 operating with M/L times oversampling is referred to as Y_{F}. Since the arithmetic operation of the frequency domain filter 183 is multiplication of coefficients for each frequency, the following is established.

$${Y}_{F} = H ∘ X \qquad ( 16 )$$

Y_{F} is a frequency domain signal of M/L times oversampling. When the frequency domain filter 183 is a MIMO filter, it is extended as indicated in the following equation 17, using i and j as an index representing a plurality of input/output signals.

$${Y}_{F i} = {\sum }_{j} {H}_{ij} {◦X}_{j} \qquad ( 17 )$$

In the present example embodiment, the rate conversion unit 184 performs rate conversion on Y_{F} being the output signal of the frequency domain filter 183, and converts Y_{F} into a frequency domain signal of one-time oversampling. Herein, the rate conversion unit 184 performs rate conversion by performing L times up-sampling (F_{↑L}) in the frequency domain, decimation filter (H_{I}) in the frequency domain, and M times down-sampling (F_{↓M}) in the frequency domain.

The rate conversion unit 184 performs L times up-sampling in the frequency domain on Y_{F}. A signal being subject to L times up-sampling is referred to as Y_{L}. Time domain representation of each of Y_{F} and Y_{L} is represented by the following equations 18 and 19, respectively.

$${Y}_{Fi} = {\sum }_{j} {H}_{ij} ∘ {X}_{j} \qquad ( 17 )$$

In that case, the following equation is established,

$${Y}_{Fi} = {\sum }_{j} {H}_{ij} ∘ {X}_{j} \qquad ( 17 )$$

then the following is established.

$${Y}_{Fi} = {\sum }_{j} {H}_{ij} ∘ {X}_{j} \qquad ( 17 )$$

From the periodicity of Y_{F}, the following equations 22 and 23 are established.

$${Y}_{L} [ k ] = {Y}_{F} [ mod ( k , {N}^{′} ) ] \qquad ( 22 )$$

$${Y}_{L} [ k + {lN}^{′} ] = {Y}_{F} [ k ] ( l = 0 , … , L - 1 ) \qquad ( 23 )$$

A size of Y_{L} is LN′. It is assumed, as Y_{I}, that Y_{F} is subjected to a decimation filter in the frequency domain. Herein, as the decimation filter, a filter whose coefficient H_{I} is represented by the following equation 24 is used.

$${H}_{I} [ k ] = \{ \begin{matrix}1 & ( \vert {kF}_{0} \vert \leq \frac{M}{2 L} {R}_{s} ) \\ 0 & ( otherwise )\end{matrix} \qquad ( 24 )$$

The above-described filter coefficient is used to limit in such a way that an output of the decimation filter becomes a band being equivalent to an input signal of M/L times oversampling, since a shape of a spectrum does not change in a linear filter in the frequency domain. A size of Y_{I} is LN′=2MN=MN″, similar to the size of Y_{L}.

A signal acquired by performing M times down-sampling in the frequency domain on Y_{I} being the output of the decimation filter is referred to as Y_{M}. Time domain representation of each of Y_{I} and Y_{M} is represented by the following equations 25 and 26, respectively.

$${y}_{I} = {( {y}_{I} ( 0 ) , {y}_{I} ( T / M ) , … , {y}_{I} ( ( {MN}^{″} - 1 ) T / M ) )}^{T} \qquad ( 25 )$$

$${y}_{M} = {( {y}_{M} ( 0 ) , {y}_{M} ( T ) , … , {y}_{M} ( ( {N}^{″} - 1 ) T ) )}^{T} \qquad ( 26 )$$

In that case, the following is established,

$${y}_{M} ( nT ) = {y}_{I} ( nT ) \qquad ( 27 )$$

and the following is established

$${Y}_{M} ( {kF}_{0} ) = \frac{1}{M} {\sum }_{m = 0}^{M - 1} {Y}_{r} ( ( k - {mN}^{′′} ) {F}_{0} ) \qquad ( 28 )$$

A size of Y_{M} is N″=2N. The signal Y_{M} is a frequency domain signal being converted into a signal of one-time oversampling by the rate conversion unit 184.

The IFFT 185 converts the frequency domain signal Y_{M} of one-time oversampling into a signal of the time domain y₊. y₊ is a time domain signal of the one-time oversampling, and a size thereof is 2N. y₊ is represented by the following equation 29 by using a domain y not being affected by assumption of the periodicity, and a domain y^{˜} that may be affected by the assumption of the periodicity, under a constraint on an appropriate filter coefficient.

$${y}_{+} = ( \begin{matrix}y \\ {y}^{-}\end{matrix} ) \qquad ( 29 )$$

The serial conversion unit 186 removes y^{˜} from y₊ represented by the above-described equation 29, and leaves y. y is a time domain signal vector of one-time oversampling, and a size thereof is N. The carrier phase compensation unit 187 performs carrier phase/frequency offset compensation on the time domain signal vector y of one-time oversampling. The carrier phase compensation unit 187 applies a phase rotation separately determined by, for example, a phase-lock loop (PLL) method to the time domain signal y. An output signal of the carrier phase compensation unit 187 is referred to as z.

When a phase rotation amount vector is referred to as θ, z is represented by the following equation 30.

$$𝓏 = 𝓎 ∘ exp ( 𝒾 θ ) \qquad ( 30 )$$

In the above-described equation 30, exp(iθ) is not a matrix exponential function, but represents a matrix (vector) acquired by performing an arithmetic operation on an exponential function for each element. A size of z is N. z is an output for one input block of the overlap-save type frequency domain filter operating in the frequency domain of M/L times oversampling.

Next, adaptive control of a filter coefficient of a frequency domain filter operating in the frequency domain of M/L times oversampling will be described. The filter coefficient of the frequency domain filter 183 is adaptively controlled by using the calculation of the gradient by error back propagation and the stochastic gradient descent method. More specifically, a gradient of the loss function for the filter coefficient is calculated by error back propagation for each input block, using, as the loss function, magnitude of a difference between the time domain signal of one-time oversampling and the desired signal determined by one-time oversampling, i.e., the predetermined value, and the coefficient is updated by the gradient descent method.

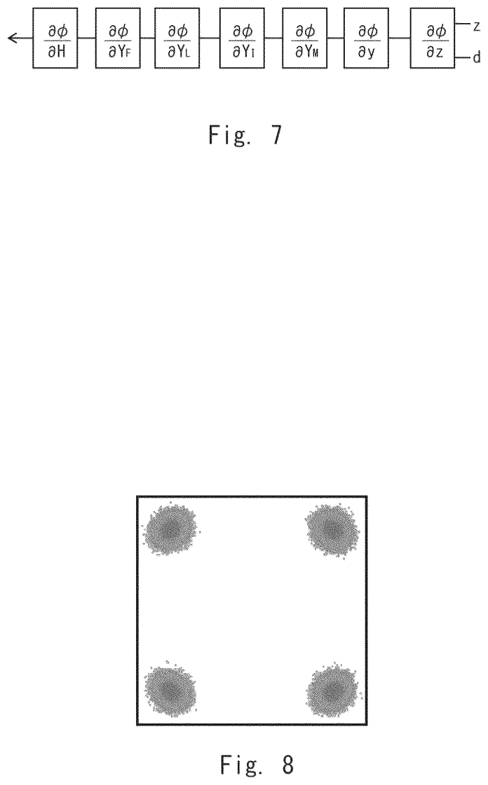

FIG. 7 illustrates a process of gradient calculation by error back propagation for coefficient updating in the gradient calculation unit 190. The loss function to be minimized is referred to as φ. From a Wirtinger derivative perspective, φ is regarded as a function of time domain signals z and z* of one-time time oversampling. * represents complex conjugate. When the LMS algorithm is used, an instantaneous value of the loss function φ for each block is magnitude of a difference between the time domain signal z of one-time oversampling and the desired signal d, as represented by the following equation 31.

$$ϕ = {\sum }_{n = 0}^{N - 1} {\vert d [ n ] - z [ n ] \vert}^{2} \qquad ( 31 )$$

When the data-aided LMS algorithm is used, d is a known training signal. When the decision-directed LMS algorithm is used, d is a result of symbol determination of z. The loss function is not limited to that described above, and several methods of constituting the loss function to be minimized from a time domain signal of one-time oversampling, such as constant modulus algorithm (CMA) or radius directed equalization (RDE), are known. Herein, the data-aided LMS algorithm is assumed to be used.

A gradient for the time domain signal z of one-time oversampling of the loss function φ is represented by the following equation 32.

$$\frac{\partial ϕ}{\partial z} = - {e}^{*} \qquad ( 32 )$$

Herein, e=d−z. Since the loss function is a real number, the following is established.

$$ϕ = {\sum }_{n = 0}^{N - 1} {\vert d [ n ] - z [ n ] \vert}^{2} \qquad ( 31 )$$

From the gradient for the time domain signal z of one-time oversampling of the loss function φ, a gradient for each signal and filter coefficient, illustrated in FIG. 7, is calculated retroactively by the error back propagation method, i.e. a relationship of a chain rule of a derivative. A gradient for y of the loss function is calculated from the gradient for z by the following equation 34.

$$ϕ = {\sum }_{n = 0}^{N - 1} {\vert d [ n ] - z [ n ] \vert}^{2} \qquad ( 31 )$$

A gradient for y₊ of the loss function is calculated, by using the gradient for y, by the following equation 35.

$$\frac{\partial ϕ}{\partial {y}_{+}} = ( \begin{matrix}\frac{\partial ϕ}{\partial y} \\ 0\end{matrix} ) \qquad ( 35 )$$

A gradient for y_{M} of the loss function is calculated, by using the gradient for y₊, by the following equation 36.

$$\frac{\partial ϕ}{\partial {Y}_{M}} = {D}^{- 1} \frac{\partial ϕ}{\partial {y}_{+}} \qquad ( 36 )$$

A gradient for y_{I} of the loss function is calculated by using the following equation 37.

$$\frac{\partial ϕ}{\partial {Y}_{I} [ k ]} = \frac{1}{M} {\sum }_{m = 0}^{M - 1} \frac{\partial ϕ}{\partial {Y}_{M} [ k + mN ]} \qquad ( 37 )$$

A gradient for y_{L} of the loss function is calculated by the following equation 38.

$$\frac{\partial ϕ}{\partial {Y}_{L}} = \frac{\partial ϕ}{\partial {Y}_{I}} ◦ {H}_{I} \qquad ( 38 )$$

A gradient for y_{F} of the loss function is calculated by using the following equation.

$$\frac{\partial ϕ}{\partial {Y}_{F} [ k ]} = {\sum }_{l = 0}^{L - 1} \frac{\partial ϕ}{\partial {Y}_{L} [ k + lN ]}$$

A gradient of the loss function for the filter coefficient H of the frequency domain filter operating in the frequency domain of M/L times oversampling is calculated by the following equation 39.

$$\frac{\partial ϕ}{\partial H} = \frac{\partial ϕ}{\partial {Y}_{F}} ∘ X \qquad ( 39 )$$

When the frequency domain filter is a MIMO filter, the above-described equation 39 is extended as in the following equation 40, where i and j are indices representing a plurality of input/output signals.

$$\frac{\partial ϕ}{\partial {H}_{ij}} = \frac{\partial ϕ}{\partial {Y}_{Fi}} {◦X}_{j} \qquad ( 40 )$$

In this way, the gradient of the loss function for the filter coefficient of the frequency domain filter operating in the frequency domain of M/L times oversampling is calculated.

The coefficient updating unit 194 updates the filter coefficient of the frequency domain filter 183 operating in the frequency domain of M/L times oversampling, based on the gradient of the loss function for the filter coefficient by the stochastic gradient descent method. More specifically, the coefficient updating unit 194 updates the filter coefficient of the frequency domain filter 183 by the following expression 41.

$$H \to H - 2 α \frac{\partial ϕ}{\partial {H}^{*}} \qquad ( 41 )$$

In the above-described expression 41, a is a step size. A second term on a right side in the above-described expression 41 corresponds to the coefficient update amount.

Similarly to a case of the normal adaptive frequency domain filter of two-times oversampling, the gradient or the coefficient update amount calculated by the gradient calculation unit 190 is subjected to a constraint operation in order to avoid an effect of the wraparound at both ends of a block of a signal assuming the periodicity. The polarization separation/carrier phase compensation 162 includes the IFFT 191, the zero replacement unit 192, and the FFT 193 as functional blocks for operating a constraint. The IFFT 191 converts the gradient of the loss function for the filter coefficient into a gradient in the time domain. The zero replacement unit 192 replaces the coefficient of the domain being equivalent to the overlap length with zero in the gradient of the loss function for the filter coefficient being converted into the time domain. The FFT 193 converts the gradient of the loss function for the filter coefficient being subject to the zero replacement into a gradient in the frequency domain. The updating of the filter coefficient can be represented by the following expression 42 by using a vector c=(10)^{T} for the appropriate coefficient zero replacement.

$$H ⟶ H - 2 α D ( c ∘ ( {D}^{- 1} \frac{\partial ϕ}{\partial {H}^{*}} ) ) \qquad ( 42 )$$

Note that, it is known that the operation of the constraint can be omitted depending on an operating condition of the adaptive frequency domain filter.

In general, there is no known method for adaptively controlling the filter coefficient of the frequency domain filter operating with oversampling of a non-integer and rational number multiple while remaining in the frequency domain of oversampling of a non-integer and rational number multiple. In the related art, an adaptive frequency domain filter operating on an input signal having an oversampling rate being less than two times and not being an integer multiple of a symbol rate includes conversion to the frequency domain of two-times oversampling. This leads to an increase in calculation amount during adaptive control of the filter coefficient.

In the present example embodiment, the rate conversion unit 184 converts, in the frequency domain, a signal of oversampling of a non-integer and rational number multiple into a signal of one-time oversampling. The gradient calculation unit 190 calculates, as a loss function, magnitude of a difference between a time domain signal being converted into a signal of one-time oversampling and a desired signal. In addition, the gradient calculation unit 190 calculates a gradient of the loss function for a filter coefficient by sequentially calculating a gradient of the loss function for a signal of each stage of a filter arithmetic operation by using the error back propagation method. The coefficient updating unit 194 updates the filter coefficient of the frequency domain filter 183 by using the gradient of the loss function for the filter coefficient. In the present example embodiment, the filter arithmetic operation and adaptive control of the filter coefficient can be performed without converting into the frequency domain of two-times oversampling. For this reason, the polarization separation/carrier phase compensation 162 can adaptively control the coefficient of the frequency domain filter 183 while reducing the calculation amount.

Subsequently, a calculation amount necessary for the filter arithmetic operation and the updating of the filter coefficient in the present example embodiment will be described. The number of times of multiplication is a main indicator of the calculation amount. From the above-described arithmetic operation of the frequency domain filter operating in the frequency domain of M/L times oversampling and the operation of adaptive control of the filter coefficient, it can be seen that the arithmetic operation of the rate conversion and the calculation of the error back propagation do not require complex multiplication. Therefore, there is no significant increase in calculation amount associated with rate conversion in the arithmetic operation of the frequency domain filter operating in the frequency domain of M/L times oversampling and adaptive control of the filter coefficient. For this reason, in the present example embodiment, when an input is oversampling smaller than two-times oversampling, it is possible to sufficiently enjoy a merit of calculation amount relaxation due to reduction in the sampling rate.

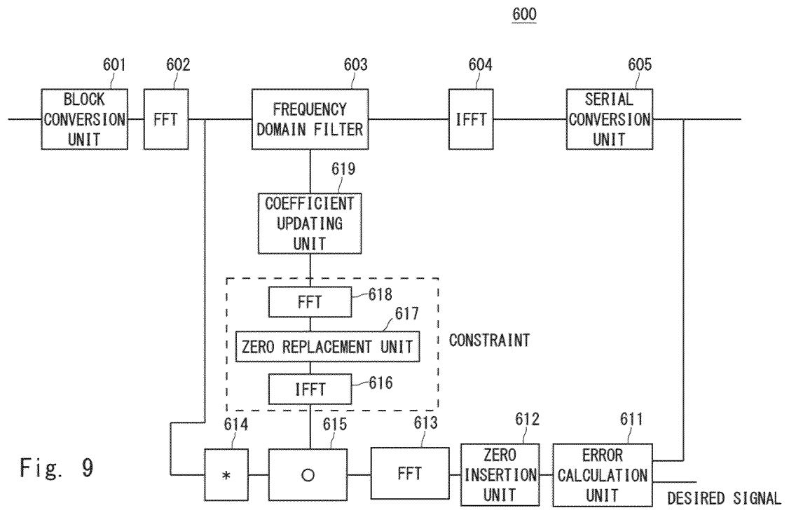

The present inventor has estimated the number of times of complex multiplication required around one input block in the present example embodiment and a comparative example. As the comparative example, it is considered a case where an input signal is a signal of two-times oversampling in the adaptive frequency domain filter illustrated in FIG. 9. The frequency domain filter is a MIMO filter of K×K, where K is a predetermined integer. The overlap rate is assumed to be 50%, and a time width of the filter, i.e., the overlap size is referred to as NT. In addition, a size of an output after the overlap removal per input block is referred to as N. A method of efficiently performing FFT and IFFT with the size n, such as a split-radix method or a prime factorization FFT, is known, and in such a method, the number of times of complex multiplication required at one time is on an order of nlog₂n. Herein, it is assumed as nlog₂n. The number of input/output signals is referred to as K.

Following Table 1 indicates the number of times of complex multiplication required per input block in the present example embodiment and the comparative example. In Table 1, Forward represents the number of times of complex multiplication required per input block in the arithmetic calculation of the frequency domain filter. In addition, Back represents the number of times of complex multiplication required per input block in updating the filter coefficient.

TABLE 1

| | PRESENT EXAMPLE EMBODIMENT | COMPARATIVE EXAMPLE |
|---|---|---|
| Forward | $\frac{2 M}{L} K + \frac{2 M}{L} {log}_{2} ( \frac{2 MN}{L} ) + 2 {log}_{2} ( 2 N ) + 1$ | 4K + 8 log₂ (4N) + 1 |
| Back | $( \frac{4 M}{L} {log}_{2} ( \frac{2 MN}{L} ) + \frac{2 M}{L} ) K + 2 {log}_{2} ( 2 N ) + 1$ | (8 log₂ (4N) + 4) K + 4 log₂ (4N) + 1 |

Referring to above-described Table 1, when M/L is smaller than 2, it can be seen that, in the present example embodiment, the number of times of complex multiplication is smaller in both the arithmetic calculation of the filter and the updating of the coefficient, as compared with a case of the adaptive frequency domain filter of two-times oversampling in the comparative example. Note that, when L=1 and M=2, the number of times of complex multiplication does not coincide between the present example embodiment and the comparative example. This is because, in the comparative example, the frequency domain filter output is converted into the time domain, and then two-times down-sampling is performed. In contrast, in the present example embodiment, down-sampling is performed in the frequency domain.

The present inventor has verified operation of the receiver side adaptive equalization signal processing system according to the present example embodiment by simulation. In the simulation, single mode fiber (SMF) 6000 km transmission is simulated for a 32 Gbaud polarization multiplexed quadrature phase shift keying (QPSK) signal. In the simulation, the QPSK signal is given chromatic dispersion being equivalent to SMF 6000 km and a random polarization rotation. In addition, an optical signal-to-noise ratio (OSNR) is set at 30 dB/0.1 nm. At a receiver, the QPSK signal is coherently received, and sampled with two-times oversampling. Line width of each of light sources on a transmitter side and a receiver side is set to 100 kHz, and a frequency offset of 100 kHz is given between a transmission light source and a reception light source which becomes a local oscillator. A signal sampled with two-times oversampling is subjected to chromatic dispersion compensation for each polarization, and resampled to M/L times oversampling. Herein, L=2 and M=3 are used.

In the simulation, a two-series signal of X polarization and Y polarization resampled to M/L times oversampling is input to an adaptive frequency domain filter operating in the frequency domain of M/L times oversampling. In the adaptive coefficient control, the loss function of the data-aided LMS algorithm is used first, and after the filter coefficient is almost converged, the filter coefficient is adaptively controlled by switching to the loss function of the decision-directed LMS algorithm. The overlap rate is set to 50%, and a size of the output after the overlap removal is set to 64. A PLL scheme is used for carrier phase compensation.

Note that, in the simulation, in order to focus on the adaptive frequency domain filter operating in the frequency domain of M/L times oversampling, resampling to M/L times oversampling is performed after chromatic dispersion compensation. Instead of performing two-times oversampling on the coherently received signal, the coherently received signal may be sampled by M/L times oversampling. In this case, the chromatic dispersion compensation is also performed with oversampling smaller than two times. For this reason, the calculation amount in the chromatic dispersion compensation is also relaxed.

FIG. 8 is a constellation of adaptive frequency domain filter output signals acquired by the above simulation. The present inventor has evaluated the constellation of the adaptive frequency domain filter output signals, after the loss function used for adaptive coefficient control is switched to the loss function of the decision-directed LMS algorithm and then the filter coefficient is sufficiently converged. FIG. 8 illustrates the constellation of a signal of X polarization. As illustrated in FIG. 8, from a simulation result, it can be seen that a good constellation of the QPSK signals is acquired. Therefore, it can be confirmed that the frequency domain filter operating in the frequency domain of M/L times oversampling and its adaptive coefficient control according to the present example embodiment normally function.

The adaptive equalization signal processing circuit according to the present example embodiment is not limited to polarization separation in single mode fiber optical transmission reception digital signal processing, and can also be used for mode separation in multi-core fiber transmission using spatial multiplexing technique. In addition, the adaptive equalization signal processing circuit according to the present example embodiment provides a method of appropriately controlling the coefficient of the adaptive filter even when there is a mismatch between a sampling rate of the input signal of the frequency domain adaptive filter and a sampling rate of the desired signal.

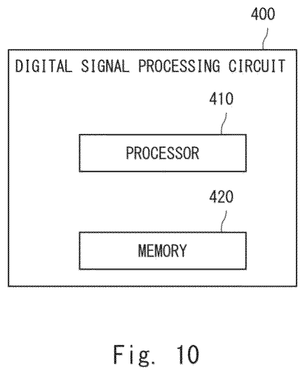

In the above-described example embodiment, the equalization unit 154 may be configured by using any digital signal processing circuit. FIG. 10 illustrates a configuration example of a digital signal processing circuit that may be used as the equalization unit 154. A digital signal processing circuit 400 is configured as a circuit including one or more processors 410, and one or more memories 420. In the digital signal processing circuit 400, one or more processors 410 read programs stored in one or more memories 420, execute processing according to the read programs, and thereby perform receiver side equalization signal processing.

A communication system, a receiver, an equalization signal processing circuit, a method, and a program according to the present disclosure can adaptively control a coefficient of a frequency domain filter while reducing calculation amount.

The above program includes instructions (or software codes) that, when loaded into a computer, cause the computer to perform one or more of the functions described in the example embodiments. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. Each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### Supplementary Note 1

An equalization signal processing circuit including:
a frequency domain conversion unit configured to convert an input signal of oversampling of a first predetermined multiple into a signal in a frequency domain;
a frequency domain filter configured to multiply an input signal being converted into the frequency domain by a coefficient for each frequency;
a rate conversion unit configured to convert a signal being multiplied by a coefficient by the frequency domain filter into a signal of oversampling of a second predetermined multiple;
a time domain conversion unit configured to convert a signal being converted into a signal of oversampling of the second predetermined multiple by the rate conversion unit into a signal in a time domain;
a gradient calculation unit configured to calculate a gradient of a loss function for the coefficient by using an error back propagation method, using, as the loss function, magnitude of a difference between a signal of oversampling of the second predetermined multiple being converted into a signal in the time domain, and a predetermined value determined by oversampling of the second predetermined multiple; and
a coefficient updating unit configured to update the coefficient of the frequency domain filter, based on the calculated gradient of the loss function for the coefficient.

### Supplementary Note 2

The equalization signal processing circuit according to supplementary note 1, wherein the second predetermined multiple is one time.

### Supplementary Note 3

The equalization signal processing circuit according to supplementary note 1 or 2, wherein an input signal of oversampling of the first predetermined multiple is a signal of M/L times oversampling, where M and L are integers satisfying 1<M/L≤2.

### Supplementary Note 4

The equalization signal processing circuit according to any one of supplementary notes 1 to 3, wherein the input signal is a signal acquired by coherently receiving a signal being transmitted via a transmission path by a receiver.

### Supplementary Note 5

The equalization signal processing circuit according to supplementary note 4, wherein the input signal is a polarization multiplexed signal, and the frequency domain filter compensates for a change in a polarization state in the transmission path.

### Supplementary Note 6

The equalization signal processing circuit according to any one of supplementary notes 1 to 5, wherein the frequency domain filter is a multi-input multi-output (MIMO) filter.

### Supplementary Note 7

The equalization signal processing circuit according to any one of supplementary notes 1 to 6, wherein the coefficient updating unit updates the coefficient by a stochastic gradient descent method, based on the gradient of the loss function for the coefficient.

### Supplementary Note 8

The equalization signal processing circuit according to any one of supplementary notes 1 to 7, further including a time domain filter configured to perform filter processing in a time domain on a signal being converted into a signal of one-time oversampling by the rate conversion unit,
wherein the gradient calculation unit calculates, as a loss function, magnitude of a difference between an output signal of the time domain filter and the predetermined value.

### Supplementary Note 9

The equalization signal processing circuit according to any one of supplementary notes 1 to 8, further including:
a block conversion unit configured to convert the input signal from a serial signal into a block signal while providing a constant overlap between blocks, and input the converted block signal to the frequency domain conversion unit; and
a serial conversion unit configured to convert a block signal to be converted into a signal in a time domain by the time domain conversion unit into a serial signal, while, by the time domain conversion unit, leaving a domain not being affected by assumption of periodicity included in a signal being converted into a signal in the time domain and removing a domain that is possibly affected by assumption of periodicity included in a signal being converted into a signal in the time domain.

### Supplementary Note 10

A receiver including:
a detector configured to coherently receive a signal being transmitted from a transmitter via a transmission path; and
an equalization signal processing circuit configured to perform equalization signal processing on the coherently received input signal of oversampling of a first predetermined multiple, wherein
the equalization signal processing circuit includes
a frequency domain conversion unit configured to convert the input signal into a signal in a frequency domain,
a frequency domain filter configured to multiply an input signal being converted into the frequency domain by a coefficient for each frequency,
a rate conversion unit configured to convert a signal being multiplied by a coefficient by the frequency domain filter into a signal of oversampling of a second predetermined multiple,
a time domain conversion unit configured to convert a signal being converted into a signal of oversampling of the second predetermined multiple by the rate conversion unit into a signal in a time domain,
a gradient calculation unit configured to calculate a gradient of a loss function for the coefficient by using an error back propagation method using, as the loss function, magnitude of a difference between a signal of oversampling of the second predetermined multiple being converted into a signal in the time domain, and a predetermined value determined by oversampling of the second predetermined multiple, and
a coefficient updating unit configured to update the coefficient of the frequency domain filter, based on the calculated gradient of the loss function for the coefficient.

### Supplementary Note 11

The receiver according to supplementary note 10, wherein the second predetermined multiple is one time.

### Supplementary Note 12

The receiver according to supplementary note 10 or 11, wherein an input signal of oversampling of the first predetermined multiple is a signal of M/L times oversampling, where M and L are integers satisfying 1<M/L≤2.

### Supplementary Note 13

The receiver according to any one of supplementary notes 10 to 12, wherein the frequency domain filter is a multi-input multi-output (MIMO) filter.

### Supplementary Note 14

A communication system including:
a transmitter configured to transmit a signal via a transmission path; and a receiver configured to receive the transmitted signal, wherein the receiver includes
a detector configured to coherently receive a signal being transmitted from the transmitter, and
an equalization signal processing circuit configured to perform equalization signal processing on the coherently received input signal of oversampling of a first predetermined multiple, and
the equalization signal processing circuit includes
a frequency domain conversion unit configured to convert the input signal into a signal in a frequency domain,
a frequency domain filter configured to multiply an input signal being converted into the frequency domain by a coefficient for each frequency,
a rate conversion unit configured to convert a signal being multiplied by a coefficient by the frequency domain filter into a signal of oversampling of a second predetermined multiple,
a time domain conversion unit configured to convert a signal being converted into a signal of oversampling of the second predetermined multiple by the rate conversion unit into a signal in a time domain,
a gradient calculation unit configured to calculate a gradient of a loss function for the coefficient by using an error back propagation method, using, as the loss function, magnitude of a difference between a signal of oversampling of the second predetermined multiple being converted into a signal in the time domain, and a predetermined value determined by oversampling of the second predetermined multiple, and
a coefficient updating unit configured to update the coefficient of the frequency domain filter, based on the calculated gradient of the loss function for the coefficient.

### Supplementary Note 15

The communication system according to supplementary note 14, wherein the second predetermined multiple is one time.

### Supplementary Note 16

The communication system according to supplementary note 14 or 15, wherein an input signal of oversampling of the first predetermined multiple is a signal of M/L times oversampling, where M and L are integers satisfying 1<M/L≤2.

### Supplementary Note 17

The communication system according to any one of supplementary notes 14 to 15, wherein the frequency domain filter is a multi-input multi-output (MIMO) filter.

### Supplementary Note 18

An equalization signal processing method including:
converting an input signal of oversampling of a first predetermined multiple into a signal in a frequency domain;
multiplying, by a frequency domain filter, an input signal being converted into the frequency domain by a coefficient for each frequency;
converting a signal being multiplied by a coefficient by the frequency domain filter into a signal of oversampling of a second predetermined multiple;
converting a signal being converted into a signal of oversampling of the second predetermined multiple into a signal in a time domain;
calculating a gradient of a loss function for the coefficient by using an error back propagation method, using, as a loss function, magnitude of a difference between a signal of oversampling of the second predetermined multiple being converted into a signal in the time domain, and a predetermined value determined by oversampling of the second predetermined multiple; and
updating the coefficient of the frequency domain filter, based on the calculated gradient of the loss function for the coefficient.

### Supplementary Note 19

A program for causing a processor to execute processing of:
converting an input signal of oversampling of a first predetermined multiple into a signal in a frequency domain;
multiplying, by a frequency domain filter, an input signal being converted into the frequency domain by a coefficient for each frequency;
converting a signal being multiplied by a coefficient by the frequency domain filter into a signal of oversampling of a second predetermined multiple;
converting a signal being converted into a signal of oversampling of the second predetermined multiple into a signal in a time domain;
calculating a gradient of a loss function for the coefficient by using an error back propagation method, using, as the loss function, magnitude of a difference between a signal of oversampling of the second predetermined multiple being converted into a signal in the time domain, and a predetermined value determined by oversampling of the second predetermined multiple; and
updating the coefficient of the frequency domain filter, based on the calculated gradient of the loss function of the coefficient.

Some or all of elements (e.g., structures and functions) specified in Supplementary Notes 2 to 9 dependent on Supplementary Note 1 may also be dependent on Supplementary Note 10, Supplementary Note 14, Supplementary Note 18, and Supplementary Note 19 in dependency similar to that of Supplementary Notes 2 to 9 on Supplementary Note 1. Some or all of elements specified in any of Supplementary Notes may be applied to various types of hardware, software, and recording means for recording software, systems, and methods.

What is claimed is:

1. An equalization signal processing circuit comprising:
at least one memory storing instructions; and
at least one processor configured to execute the instructions to:
convert an input signal of oversampling of a first predetermined multiple into a signal in a frequency domain;
input an input signal being converted into the frequency domain to a frequency domain filter, and multiply the input signal being converted into the frequency domain by a coefficient for each frequency by the frequency domain filter;
convert a signal being multiplied by a coefficient by the frequency domain filter into a signal of oversampling of a second predetermined multiple;
convert a signal being converted into a signal of oversampling of the second predetermined multiple into a signal in a time domain;
calculate a gradient of a loss function for the coefficient by using an error back propagation method using, as the loss function, magnitude of a difference between a signal of oversampling of the second predetermined multiple being converted into a signal in the time domain, and a predetermined value determined by oversampling of the second predetermined multiple; and
update the coefficient of the frequency domain filter, based on the calculated gradient of the loss function for the coefficient.

2. The equalization signal processing circuit according to claim 1, wherein the second predetermined multiple is one time.

3. The equalization signal processing circuit according to claim 1, wherein an input signal of oversampling of the first predetermined multiple is a signal of M/L times oversampling, where M and L are integers satisfying 1<M/L≤2.

4. The equalization signal processing circuit according to claim 1, wherein the input signal is a signal acquired by coherently receiving a signal being transmitted via a transmission path by a receiver.

5. The equalization signal processing circuit according to claim 4, wherein the input signal is a polarization multiplexed signal, and the frequency domain filter compensates for a change in a polarization state in the transmission path.

6. The equalization signal processing circuit according to claim 1, wherein the frequency domain filter is a multi-input multi-output (MIMO) filter.

7. The equalization signal processing circuit according to claim 1, wherein the at least one processor is configured to execute the instructions to update the coefficient by a stochastic gradient descent method, based on the gradient of the loss function for the coefficient.

8. The equalization signal processing circuit according to claim 1, wherein
the at least one processor is further configured to execute the instructions to perform filter processing in a time domain on a signal being converted into the signal of one-time oversampling, and
the at least one processor is configured to execute the instructions to calculate, as a loss function, magnitude of a difference between an output signal of the time domain filter and the predetermined value.

9. The equalization signal processing circuit according to claim 1, wherein the at least one processor is further configured to execute the instructions to:
convert the input signal from a serial signal into a block signal while providing a constant overlap between blocks, convert the converted block signal into a signal in the frequency domain, and input the converted signal to the frequency domain filter, and
convert a block signal to be converted into a signal in the time domain into a serial signal, while leaving a domain not being affected by assumption of periodicity included in a signal being converted into a signal in the time domain and removing a domain that is possibly affected by assumption of periodicity included in a signal being converted into a signal in the time domain.

10. A receiver comprising:
a detector configured to coherently receive a signal being transmitted from a transmitter via a transmission path; and
the equalization signal processing circuit according to claim 1,
wherein the equalization signal processing circuit performs equalization signal processing on the coherently received input signal of oversampling of a first predetermined multiple.

11. The receiver according to claim 10, wherein the second predetermined multiple is one time.

12. The receiver according to claim 10, wherein an input signal of oversampling of the first predetermined multiple is a signal of M/L times oversampling, where M and L are integers satisfying 1<M/L≤2.

13. The receiver according to claim 10, wherein the frequency domain filter is a multi-input multi-output (MIMO) filter.

14. A communication system comprising:
a transmitter configured to transmit a signal via a transmission path; and
the receiver according to claim 10.

15. The communication system according to claim 14, wherein the second predetermined multiple is one time.

16. The communication system according to claim 14, wherein an input signal of oversampling of the first predetermined multiple is a signal of M/L times oversampling, where M and L are integers satisfying 1<M/L≤2.

17. The communication system according to claim 14, wherein the frequency domain filter is a multi-input multi-output (MIMO) filter.

18. An equalization signal processing method comprising:
converting an input signal of oversampling of a first predetermined multiple into a signal in a frequency domain;
multiplying, by a frequency domain filter, an input signal being converted into the frequency domain by a coefficient for each frequency;
converting a signal being multiplied by a coefficient by the frequency domain filter into a signal of oversampling of a second predetermined multiple;
converting a signal being converted into a signal of oversampling of the second predetermined multiple into a signal in a time domain;
calculating a gradient of a loss function for the coefficient by using an error back propagation method using, as the loss function, magnitude of a difference between a signal of oversampling of the second predetermined multiple being converted into a signal in the time domain, and a predetermined value determined by oversampling of the second predetermined multiple; and
updating the coefficient of the frequency domain filter, based on the calculated gradient of the loss function for the coefficient.

19. A non-transitory computer readable medium storing a program for causing a processor to execute processing of:
converting an input signal of oversampling of a first predetermined multiple into a signal in a frequency domain;
multiplying, by a frequency domain filter, an input signal being converted into the frequency domain by a coefficient for each frequency;
converting a signal being multiplied by a coefficient by the frequency domain filter into a signal of oversampling of a second predetermined multiple;
converting a signal being converted into a signal of oversampling of the second predetermined multiple into a signal in a time domain;
calculating a gradient of a loss function for the coefficient by using an error back propagation method using, as the loss function, magnitude of a difference between a signal of oversampling of the second predetermined multiple being converted into a signal in the time domain, and a predetermined value determined by oversampling of the second predetermined multiple; and
updating the coefficient of the frequency domain filter, based on the calculated gradient of the loss function for the coefficient.
